(19) United States
(12) Patent Application Publication
(10) Pub. No.: US 2020/0347950 A1
(43) Pub. Date: Nov. 5, 2020

(54) AIRCRAFT ONE-PIECE FUEL NONRETURN DEVICE AND METHOD FOR MANUFACTURING SUCH A DEVICE

(71) Applicant: Zodiac Aerotechnics, Roche-la-Molière (FR)

(72) Inventor: François CORMAN, Lyon (FR)

(73) Assignee: Zodiac Aerotechnics, Roche-la-Molière (FR)

(21) Appl. No.: 16/765,178

(22) PCT Filed: Nov. 5, 2018
(86) PCT No.: PCT/FR2018/052713

§ 371 Date: May 19, 2020

(30) Foreign Application Priority Data
Nov. 21, 2017 (FR) 1760998

(51) Int. Cl. F16K 27/02; F16K 15/02; F16K 15/14

(52) U.S. Cl. CPC F16K 27/0209; F16K 15/14; F16K 15/026

(57) ABSTRACT

The invention relates to a fluid nonreturn device (1) comprising a body (2) defining a chamber (5) intended to receive a fluid and having at least one opening (3), the chamber (5) has an internal wall (6) extended by an elastic return member (8) which forms an integral part of said internal wall (6), said elastic return member (8) is extended by a valve shutter (9) forming an integral part of said elastic return member (8), the elastic return member (8) pushes the valve shutter (9) into a position in which it closes off the opening (3) so as to prevent the fluid in the chamber (5) from leaving via the opening (3).

### TECHNICAL FIELD

The present invention relates to the technical field of fuel circulation in an aircraft, such as an airplane, a helicopter or other, and more particularly relates to a nonreturn device capable of being installed in the circuit, and a method for manufacturing said device.

### PRIOR ART

Nonreturn devices such as ball valves, flap valves and the like are known from the prior art. Their operation consists of permitting a fluid, e.g. fuel, to flow in only one direction through a pipe. All these devices comprise several components. In particular, they comprise a spring-type elastic element which pushes a blocking element, such as a ball, a valve etc., into a closing position. Thus, the fluid, under a certain pressure, can flow against the blocking element by compressing the spring, but its return is blocked by said blocking element.

This type of nonreturn device generally has the disadvantage that the components that make it up do not allow electrical continuity between them. To avoid the appearance of an electrostatic charge, which is an explosion hazard in the field of aeronautics, it is necessary to connect the components together, for example with conductive wires, or to implement additional surface treatments and protections, making the manufacturing process more complex and thus increasing its cost.

Moreover, the manufacture of this type of nonreturn device involves mounting and assembly operations, and involves the use of additional components, such as screws, washers, seals, etc. and/or specific operations, such as crimping operations, etc., requiring suitable tools and machines.

As a result, the design and manufacture of this type of nonreturn device is time-consuming, costly and tedious.

Furthermore, the available spring shapes are limited. This gives the designer a limited choice of spring characteristics, such as e.g. the stiffness or progressiveness thereof.

### BRIEF DESCRIPTION OF THE INVENTION

One of the aims of the invention is therefore to solve these drawbacks by proposing a nonreturn device that is simple and inexpensive in design, and the electrical continuity of which is optimal.

Another purpose of the invention is to provide such a nonreturn device having an expanded choice of elastic behaviors and characteristics in order to thereby improve the performance of the device, for example by better addressing the problem of vibration and resonance.

In order to solve the above-mentioned problems, a fluid nonreturn device has been developed, comprising a body defining a chamber intended for receiving a fluid, and having at least one opening. The chamber has an internal wall extended by an elastic return member which forms an integral part with said internal wall, said elastic return member is extended by a valve shutter forming an integral part with said elastic return member. The elastic return member pushes the valve shutter into a position in which it closes off the opening so as to prevent the fluid present in the chamber from leaving via the opening.

In this way, the nonreturn device is one-piece so that the electrical continuity is optimally ensured. The device is more secured and easier to install. The risk of intermetallic corrosion, such as between stainless steel or aluminum, is thus minimized or even eliminated.

According to other advantageous features, considered alone or in combination:
the body, the elastic return member and the valve shutter are made of plastic material;
the body, the elastic return member and the valve shutter are made of metal;
the elastic return member is a helical compression spring;
the elastic return member is a leaf spring;
a seal is placed in a seat arranged around the opening or around the valve shutter to ensure a tight seal between the valve shutter and the body;
the opening has a sloping peripheral wall, and the valve shutter has a complementary sloping rim;
the sloping rim of the valve shutter has a peripheral annular groove forming the seal seat;
the body has a tubular conformation defining a chamber between an upstream opening and a downstream opening, the elastic return member extending the internal wall of the chamber from the downstream opening and extending so that the valve shutter closes the upstream opening.

In this way the invention proposes a nonreturn device that is simple, inexpensive and offers more possibilities of adaptation during the design.

The invention also relates to a method for manufacturing the nonreturn device. According to the invention, it consists of manufacturing, layer by layer and by additive manufacturing, the body, the elastic return member and the valve shutter, so that the body, the elastic return member and the valve shutter together form a single one-piece part. The device is manufactured so that:
the body defines a chamber intended for receiving a fluid, and has at least one opening;
the chamber has an internal wall extended by the elastic return member;
the elastic return member is extended by the valve shutter and pushes said valve shutter into a position in which it closes off the opening so as to prevent the fluid present in the chamber from leaving via the opening.

### BRIEF DESCRIPTION OF THE DRAWINGS

Further characteristics and advantages of the invention will become apparent from the description provided below, which is for reference only and is in no way restrictive, with reference to the accompanying figures, in which:

FIG. 1 is a longitudinal sectional schematic view of the nonreturn device according to the invention;

FIG. 2 is a longitudinal sectional schematic view of the nonreturn device of the invention, according to a second embodiment.

### DETAILED DESCRIPTION OF THE INVENTION

The invention relates to a fluid nonreturn device (1) capable of being installed in a fluid circuit, for example in a fuel circuit in an aircraft.

The device (1) according to the invention is made of composite material, metal, ceramic, stainless steel, plastic, or any suitable material, layer by layer, by an additive manufacturing technique. Metal is preferred due to its compatibility with fuel.

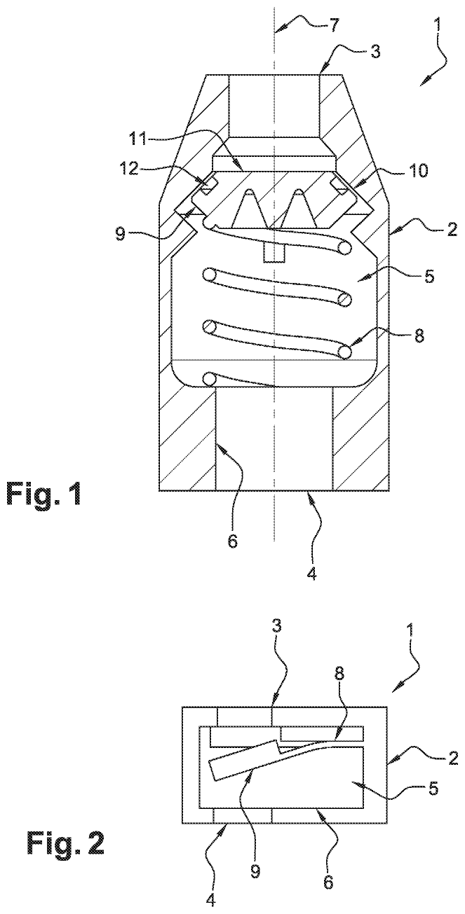

According to a first embodiment of the invention, shown in FIG. 1, the device (1) comprises a body (2) that is substantially cylindrical, elongate and axially symmetrical. The body (2) has at its ends two openings, one upstream (3), the other downstream (4). The body (2) defines a chamber (5) intended for receiving the fluid that can flow from the upstream opening (3) towards the downstream opening (4), but which is prevented from returning towards the upstream opening (3), as will be explained in greater detail below. The terms “upstream” and “downstream” relate to the direction of flow of the fluid permitted by the nonreturn device (1).

The chamber (5) has an internal wall (6) with a tubular conformation along the central longitudinal axis (7), and has a variable diameter along the device (1).

The internal wall (6) is extended by an elastic return member (8) forming an integral part with said internal wall (6). According to this first embodiment, the elastic return member (8) is a helical spring. The spring (8) is extended by a valve shutter (9) forming an integral part with said spring (8). In other words, the internal wall (6), the spring (8) and the valve shutter (9) form a one-piece assembly. The spring (8) extends the internal wall (6) from the downstream opening (4) and extends in order for the valve shutter (9) to close the upstream opening (3).

Of course, the spring (8) can have shapes different from that shown, for example the spring (8) can comprise a variable diameter along the central axis (7).

The wire that constitutes the spring (8) can also have a variable diameter along the spring (8) to advantageously have a progressive nature. Thus, the spring (8) can have a non-linear opening curve, which makes it possible to better address certain requirements such as good performance under vibration.

The internal wall (6) likewise has a seat (10) for the valve shutter (9). When the device (1) is made of metal, the seat (10) of the valve shutter (9) advantageously has a conical upstream conformation, with its largest diameter located downstream. The upstream portion of the valve shutter (9) has a complementary conical conformation. Indeed, the conical conformations facilitate the additive manufacturing operation and prevent the seat (10) from collapsing under its own weight. Conversely, if the device is made of plastic, for example, the conical conformation is not necessary and the seat (10) can be made in the form of an orthogonal shoulder with respect to the central axis (7).

According to a particular embodiment, the wall of the seat (10) and the complementary rim of the valve shutter (9) define an angle of between 30 and 60 degrees with respect to the central axis (7). At the upstream end (11) of the valve shutter (9), a radial clearance is present between the valve shutter (9) and the internal wall (6). The clearance is smaller than 0.2 mm, for example equal to 0.1 mm. Likewise, a clearance is present between the sloping walls of the valve shutter (9) and the internal wall (6), and is smaller than 0.6 mm, for example equal to 0.495 mm. The seat (10) of the valve shutter (9) likewise has a portion located downstream with a conical conformation, but with a smaller diameter downstream than upstream. The valve shutter (9) has a complementary conformation. Thus, when the valve shutter (9) is shifted towards the downstream opening (4), against the spring (8), it is capable of bearing against the conical portion of the wall (6). The travel of the valve shutter (9) is thus limited and the spring (8) is protected against exceeding the yield point, for example. As already mentioned, the conical conformation facilitates the manufacture of a metal part, and is not necessary with a plastic part.

To ensure a tight seal in the closed position, the valve shutter (9) has a seat (12) in the form of a peripheral annular groove arranged on the circumference of the valve shutter (9), in order to receive a seal. The seal (not shown) can be, for example, a fluorosilicone O-ring. Of course, the seal can alternatively be placed in a groove formed in the internal wall (6). The seal is larger than the radial clearance present between the valve shutter (9) and the internal wall (6), in order to ensure the tight seal. The seal is positioned after manufacturing the device (1).

At rest, the spring (8) pushes the valve shutter (9) against the seat (10). Thus, the seal is pressed against the wall (6) and prevents the return of fluid towards the upstream opening (3). To penetrate into the device (1) via the upstream opening (3), the fluid exerts a pressure on the valve shutter (9). When the pressure is sufficient, the spring (8) is compressed and the fluid can flow into the chamber (5), through the space between the wall (6) and the valve shutter (9) and towards the downstream opening (4). Of course, the necessary pressure level is determined by the stiffness of the spring (8).

When the pressure exerted upstream is lower than a certain threshold, the valve shutter (9) is pushed against the seat (10) of the valve shutter (9), in particular by the spring (8) and optionally an internal pressure. The seal bears against the internal wall (6) and prevents the return of fluid through the upstream opening (3).

In reference to FIG. 2, and according to a second embodiment, the elastic return member is a leaf spring (8). The leaf spring (8) extends the internal wall (6) laterally, and is extended by the valve shutter (9), with the wall (6), the leaf spring (8) and the valve shutter (9) forming a one-piece assembly.

Of course, the leaf spring (8) can be manufactured in any appropriate manner, for example as a single leaf or as two leaves, one on either side of the valve shutter (9), etc. The leaf or leaves can have a variable section in order best to adapt the elastic behavior of the spring (8) to requirements.

Advantageously, the method for manufacturing the device (1) according to the invention consists of manufacturing, layer by layer and by additive manufacturing, the body (2), the elastic return member (8) and the valve shutter (9), so that the body (2), the elastic return member (8) and the valve shutter (9) together form a single one-piece part, the device (1) being manufactured so that:
the body (2) defines a chamber (5) intended for receiving a fluid, and has at least one opening (3);
the chamber (5) has an internal wall (6) extended by the elastic return member (8);
the elastic return member is extended by the valve shutter (9) and pushes said valve shutter (9) into a position in which it closes off the opening (3) so as to prevent the fluid in the chamber (5) from leaving via the opening (3).

Thus, the device (1) according to the invention is one-piece. In other words, there is only one part to be managed in terms of design, validation, manufacturing, procurement, storage. Manufacturing is easy, quick and inexpensive. Moreover, given that the device (1) is made as a single part, with no fastening means, the electrical continuity is optimal, the device is lighter and the risk of intermetallic corrosion is minimized or even eliminated.

The invention makes it possible to avoid handling and assembly operations, and to improve the repeatability of the method.

1. A fuel nonreturn device (1) comprising a body (2) defining a chamber (5) intended for receiving a fuel and having at least one opening (3), the chamber (5) has an internal wall (6) extended by an elastic return member (8) which forms an integral part of said internal wall (6), said elastic return member (8) is extended by a valve shutter (9) forming an integral part with said elastic return member (8), the elastic return member (8) pushes the valve shutter (9) into a position in which it closes off the opening (3) so as to prevent the fuel present in the chamber (5) from leaving via the opening (3).

2. The device (1) according to claim 1, characterized in that the body (2), the elastic return member (8) and the valve shutter (9) are made of plastic material.

3. The device (1) according to claim 1, characterized in that the body (2), the elastic return member (8) and the valve shutter (9) are made of metal.

4. The device (1) according to claim 1, characterized in that the elastic return member (8) is a helical compression spring.

5. The device (1) according to claim 1, characterized in that the elastic return member (8) is a leaf spring.

6. The device (1) according to claim 1, characterized in that a seal is placed in a seat (12) arranged around the opening (3) or around the valve shutter (9) to ensure a tight seal between the valve shutter (9) and the body (2).

7. The device (1) according to claim 1, characterized in that the opening has a sloping peripheral wall (6), and the valve shutter (9) has a complementary sloping rim.

8. The device (1) according to claim 7, characterized in that the sloping rim of the valve shutter (9) has a peripheral annular groove forming the seat (12) of a seal.

9. The device (1) according to claim 1, characterized in that the body (2) has a tubular conformation defining a chamber (5) between a downstream opening (4) and an upstream opening (3), the elastic return member (8) extending the internal wall (6) of the chamber (5) from the downstream opening (4) and extends so that the valve shutter (9) closes off the upstream opening (3).

10. A method for manufacturing a fuel nonreturn device (1) according to claim 1, characterized in that it consists of manufacturing, layer by layer and by additive manufacturing, the body (2), the elastic return member (8) and the valve shutter (9), so that the body (2), the elastic return member (8) and the valve shutter (9) together form a single one-piece part, the device (1) being manufactured so that:
the body (2) defines a chamber (5) intended for receiving a fuel, and has at least one opening (3);
the chamber (5) has an internal wall (6) extended by the elastic return member (8);
the elastic return member is extended by the valve shutter (9) and pushes said valve shutter (9) into a position in which it closes off the opening (3) so as to prevent the fuel present in the chamber (5) from leaving via the opening (3).

11. A method for manufacturing a fuel nonreturn device (1) according to claim 2, characterized in that it consists of manufacturing, layer by layer and by additive manufacturing, the body (2), the elastic return member (8) and the valve shutter (9), so that the body (2), the elastic return member (8) and the valve shutter (9) together form a single one-piece part, the device (1) being manufactured so that:
the body (2) defines a chamber (5) intended for receiving a fuel, and has at least one opening (3);
the chamber (5) has an internal wall (6) extended by the elastic return member (8);
the elastic return member is extended by the valve shutter (9) and pushes said valve shutter (9) into a position in which it closes off the opening (3) so as to prevent the fuel present in the chamber (5) from leaving via the opening (3).

12. A method for manufacturing a fuel nonreturn device (1) according to claim 3, characterized in that it consists of manufacturing, layer by layer and by additive manufacturing, the body (2), the elastic return member (8) and the valve shutter (9), so that the body (2), the elastic return member (8) and the valve shutter (9) together form a single one-piece part, the device (1) being manufactured so that:
the body (2) defines a chamber (5) intended for receiving a fuel, and has at least one opening (3);
the chamber (5) has an internal wall (6) extended by the elastic return member (8);
the elastic return member is extended by the valve shutter (9) and pushes said valve shutter (9) into a position in which it closes off the opening (3) so as to prevent the fuel present in the chamber (5) from leaving via the opening (3).

13. A method for manufacturing a fuel nonreturn device (1) according to claim 4, characterized in that it consists of manufacturing, layer by layer and by additive manufacturing, the body (2), the elastic return member (8) and the valve shutter (9), so that the body (2), the elastic return member (8) and the valve shutter (9) together form a single one-piece part, the device (1) being manufactured so that:
the body (2) defines a chamber (5) intended for receiving a fuel, and has at least one opening (3);
the chamber (5) has an internal wall (6) extended by the elastic return member (8);
the elastic return member is extended by the valve shutter (9) and pushes said valve shutter (9) into a position in which it closes off the opening (3) so as to prevent the fuel present in the chamber (5) from leaving via the opening (3).

14. A method for manufacturing a fuel nonreturn device (1) according to claim 5, characterized in that it consists of manufacturing, layer by layer and by additive manufacturing, the body (2), the elastic return member (8) and the valve shutter (9), so that the body (2), the elastic return member (8) and the valve shutter (9) together form a single one-piece part, the device (1) being manufactured so that:
the body (2) defines a chamber (5) intended for receiving a fuel, and has at least one opening (3);
the chamber (5) has an internal wall (6) extended by the elastic return member (8);
the elastic return member is extended by the valve shutter (9) and pushes said valve shutter (9) into a position in which it closes off the opening (3) so as to prevent the fuel present in the chamber (5) from leaving via the opening (3).

15. A method for manufacturing a fuel nonreturn device (1) according to claim 6, characterized in that it consists of manufacturing, layer by layer and by additive manufacturing, the body (2), the elastic return member (8) and the valve shutter (9), so that the body (2), the elastic return member (8) and the valve shutter (9) together form a single one-piece part, the device (1) being manufactured so that:
the body (2) defines a chamber (5) intended for receiving a fuel, and has at least one opening (3);
the chamber (5) has an internal wall (6) extended by the elastic return member (8);
the elastic return member is extended by the valve shutter (9) and pushes said valve shutter (9) into a position in which it closes off the opening (3) so as to prevent the fuel present in the chamber (5) from leaving via the opening (3).

16. A method for manufacturing a fuel nonreturn device (1) according to claim 7, characterized in that it consists of manufacturing, layer by layer and by additive manufacturing, the body (2), the elastic return member (8) and the valve shutter (9), so that the body (2), the elastic return member (8) and the valve shutter (9) together form a single one-piece part, the device (1) being manufactured so that:
the body (2) defines a chamber (5) intended for receiving a fuel, and has at least one opening (3);
the chamber (5) has an internal wall (6) extended by the elastic return member (8);
the elastic return member is extended by the valve shutter (9) and pushes said valve shutter (9) into a position in which it closes off the opening (3) so as to prevent the fuel present in the chamber (5) from leaving via the opening (3).

17. A method for manufacturing a fuel nonreturn device (1) according to claim 8, characterized in that it consists of manufacturing, layer by layer and by additive manufacturing, the body (2), the elastic return member (8) and the valve shutter (9), so that the body (2), the elastic return member (8) and the valve shutter (9) together form a single one-piece part, the device (1) being manufactured so that:
the body (2) defines a chamber (5) intended for receiving a fuel, and has at least one opening (3);
the chamber (5) has an internal wall (6) extended by the elastic return member (8);
the elastic return member is extended by the valve shutter (9) and pushes said valve shutter (9) into a position in which it closes off the opening (3) so as to prevent the fuel present in the chamber (5) from leaving via the opening (3).

18. A method for manufacturing a fuel nonreturn device (1) according to claim 9, characterized in that it consists of manufacturing, layer by layer and by additive manufacturing, the body (2), the elastic return member (8) and the valve shutter (9), so that the body (2), the elastic return member (8) and the valve shutter (9) together form a single one-piece part, the device (1) being manufactured so that:
the body (2) defines a chamber (5) intended for receiving a fuel, and has at least one opening (3);
the chamber (5) has an internal wall (6) extended by the elastic return member (8);
the elastic return member is extended by the valve shutter (9) and pushes said valve shutter (9) into a position in which it closes off the opening (3) so as to prevent the fuel present in the chamber (5) from leaving via the opening (3).
